(19) United States
(12) Patent Application Publication
(10) Pub. No.: US 2024/0323609 A1
(43) Pub. Date: Sep. 26, 2024

(54) ELECTRONIC DEVICE AND CONTROL METHOD THEREFOR

(71) Applicant: SAMSUNG ELECTRONICS CO., LTD., Suwon-si (KR)

(72) Inventors: Youngsuk SONG, Suwon-si (KR); Hanki KIM, Suwon-si (KR); Donghyun LIM, Suwon-si (KR); Haekwang PARK, Suwon-si (KR)

(73) Assignee: SAMSUNG ELECTRONICS CO., LTD., Suwon-si (KR)

(21) Appl. No.: 18/733,324

(22) Filed: Jun. 4, 2024

Related U.S. Application Data
(63) Continuation of application No. PCT/KR2022/021030, filed on Dec. 22, 2022.

(30) Foreign Application Priority Data
Dec. 22, 2021 (KR) 10-2021-0185458

(51) Int. Cl. H04R 5/04; G06F 3/16; H04R 5/02; H04S 3/00

(52) U.S. Cl. CPC H04R 5/04; G06F 3/162; H04R 5/02; H04S 3/008; H04R 2420/07; H04S 2400/01

(57) ABSTRACT

An electronic device and a control method thereof is provided. The electronic device control method may include receiving audio data and data on the audio data including a presentation time stamp information indicating when the audio data is required to be output, and a time stamp information of an external device; synchronizing a system time of the electronic device with a system time of the external device by using the time stamp information of the electronic device and of the external device; storing the audio data in a buffer based on the system time of the electronic device and the presentation time stamp information; outputting the audio data stored in the buffer by a first audio clock through a speaker of the electronic device; and changing the first audio clock by comparing the audio data stored in the buffer with a predetermined buffer amount.

### CROSS-REFERENCES TO RELATED APPLICATIONS

This application is a continuation of International Application No. PCT/KR2022/021030 filed at the Korean Intellectual Property Office on Dec. 22, 2022, which claims priority to Korean Patent Application No. 10-2021-0185458 filed at the Korea Intellectual Property Office on Dec. 22, 2021, the disclosure of which are incorporated herein by reference in their entireties.

### FIELD

The present disclosure relates to an electronic device and a control method therefor, i.e., an electronic device which may output audio data in synchronization with an external device, and a control method therefor.

### BACKGROUND

In accordance to the recent development of audio technology, there has been an increasing need of a consumer who wants to experience a wide sound stage through an audio device (for example, a sound bar or an external speaker) connected to a television (TV).

Meanwhile, sound may be output simultaneously from a speaker built in the TV and the external audio device. In this case, due to a difference between audio data processing time of the TV and that of the external audio device, the sound output from the speaker built in the TV and the sound output from the external audio device may be out of synchronization (sync).

Accordingly, there is an emerging need for technology for an electronic device which may output the sound in synchronization with the external device.

In addition, in case of transmitting and receiving the data through Bluetooth, the external device and the electronic device may transmit and receive only up to 2 channels of audio.

Accordingly, the external device and the electronic device may transmit and receive multi-channel audio in case of transmitting and receiving the data by using wireless fidelity (WiFi) through a WiFi access point (AP), which may increase delay time of the audio data.

### SUMMARY

The present disclosure is directed to a method for controlling an electronic device. The method may include receiving audio data and data on the audio data, wherein data on the audio data comprises a presentation time stamp information indicating when the audio data is required to be output, and a time stamp information of an external device; synchronizing a system time of the electronic device with a system time of the external device by using a time stamp information of the electronic device and the time stamp information of the external device; storing the audio data in a buffer in the memory of the electronic device based on the system time of the electronic device and the presentation time stamp information; outputting the audio data stored in the buffer by a first audio clock through a speaker of the electronic device; and changing the first audio clock by comparing the audio data stored in the buffer with a predetermined buffer amount.

The present disclosure is directed to an electronic device that may include a communication interface; a speaker; memory storing at least one instruction; and at least one processor connected to the memory and configured to control the electronic device. The at least on processor may execute the at least one instruction which may cause the at least one processor to receive audio data and data on the audio data, wherein data on the audio data comprises a presentation time stamp information indicating when the audio data is required to be output, and a time stamp information of an external device, synchronize a system time of the electronic device with a system time of the external device by using a time stamp information of the electronic device and the time stamp information of the external device, store the audio data in a buffer in the memory based on the system time of the electronic device and the presentation time stamp information, output the audio data stored in the buffer by a first audio clock through the speaker, and change the first audio clock by comparing the audio data stored in the buffer with a predetermined buffer amount.

The present disclosure is directed to a non-transitory computer-readable medium. The non-transitory computer-readable medium may include a program that, when executed by at least one processor, may cause the at least on processor to receive audio data, wherein data on the audio data comprises a presentation time stamp information indicating when the audio data is required to be output, and a time stamp information of an external device, synchronize a system time of the electronic device with a system time of the external device by using a time stamp information of the electronic device and the time stamp information of the external device, store the audio data in a buffer in the memory of the electronic device based on the system time of the electronic device and the presentation time stamp information, output the audio data stored in the buffer by a first audio clock through a speaker of the electronic device, and change the first audio clock by comparing the audio data stored in the buffer with a predetermined buffer amount.

### BRIEF DESCRIPTION OF THE DRAWINGS

FIG. 1 is a diagram for illustrating operations of an electronic device and an external device according to an embodiment of the present disclosure.

FIG. 2 is a block diagram for illustrating a configuration of the electronic device according to an embodiment of the present disclosure.

FIG. 3 is a diagram for illustrating an operation of the electronic device according to an embodiment of the present disclosure.

FIGS. 4 to 7 are diagrams for illustrating an exemplary a method of changing an audio clock of the electronic device.

FIG. 8 is a diagram for illustrating operations of the electronic device and the external device according to an embodiment of the present disclosure.

FIG. 9 is a diagram for illustrating a control method of an electronic device according to an embodiment of the present disclosure.

### DETAILED DISCLOSURE

The present disclosure may be variously modified and have several embodiments, and specific embodiments of the present disclosure are thus illustrated in the drawings and described in detail in the detailed description. However, it is to be understood that the scope of the present disclosure is not limited to the specific embodiments, and include various modifications, equivalents, and/or alternatives according to the embodiments of the present disclosure. Throughout the accompanying drawings, similar components are denoted by similar reference numerals.

In describing the present disclosure, omitted is a detailed description of a case where it is decided that a detailed description of the known functions or configurations related to the present disclosure may unnecessarily obscure the gist of the present disclosure.

In addition, the embodiments described below may be modified in several different forms, and the scope and spirit of the present disclosure are not limited to the embodiments. Rather, these embodiments make the present disclosure thorough and complete, and are provided to completely deliver the spirit of the present disclosure to those skilled in the art.

Terms used in the present disclosure are used only to describe the specific embodiments rather than limiting the scope of the present disclosure. A term of a singular number used herein is intended to include its plural number unless explicitly indicated otherwise.

In the present disclosure, an expression “have”, “may have”, “include”, “may include” or the like, indicates existence of a corresponding feature (for example, a numerical value, a function, an operation, or a component such as a part), and does not exclude existence of an additional feature.

In the present disclosure, an expression “A or B”, “at least one of A and/or B”, “one or more of A and/or B” or the like, may include all possible combinations of items enumerated together. For example, “A or B”, “at least one of A and B” or “at least one of A or B” may indicate all of 1) a case where at least one A is included, 2) a case where at least one B is included, or 3) a case where both of at least one A and at least one B are included.

Expressions “first”, “second” and the like, used in the present disclosure, may indicate various components regardless of the sequence and/or importance of the components. These expressions are used only to distinguish one component from another component, and do not limit the corresponding component.

In case that any component (for example, a first component) is mentioned to be “(operatively or communicatively) coupled with/to” or “connected to” another component (for example, a second component), it is to be understood that any component is directly coupled to another component or coupled to another component through still another component (for example, a third component).

On the other hand, in case that any component (for example, the first component) is mentioned to be “directly coupled to” or “directly connected to” another component (for example, the second component), it is to be understood that still another component (for example, the third component) is not present between any component and another component.

An expression “configured (or set) to” used in the present disclosure may be replaced by an expression “suitable for”, “having the capacity to”, “designed to”, “adapted to”, “made to” or “capable of” based on a situation. The expression “configured (or set) to” may not necessarily indicate “specifically designed to” in hardware.

Instead, an expression “a device configured to” in any situation may indicate that the device may “perform˜” together with another device or component. For example, “a processor configured (or set) to perform A, B and C” may indicate a dedicated processor (for example, an embedded processor) that may perform the corresponding operations or a generic-purpose processor (for example, a central processing unit (CPU) or an application processor) that may perform the corresponding operations by executing one or more software programs stored in a memory device.

In the embodiments, a “module” or a “˜er/or” may perform at least one function or operation, and be implemented by hardware or software or be implemented by a combination of hardware and software. In addition, a plurality of “modules” or a plurality of “˜ers/ors” may be integrated in at least one module and implemented by at least one processor except for a “module” or an “˜er/or” that needs to be implemented by specific hardware.

Meanwhile, various elements and regions in the drawings are schematically shown. Therefore, the spirit of the present disclosure is not limited by relative sizes or intervals shown in the accompanying drawings.

The present disclosure provides an electronic device which may output audio data in synchronization with an external device, and a control method therefor. In addition, the present disclosure provides an electronic device which may transmit and receive multi-channel audio data with minimum delay time and output the transmitted and received audio data in synchronization with an external device, and a control method therefor.

The technical problems to be solved by the present disclosure are not limited to the above-mentioned problems, and any other technical problems not mentioned herein will be clearly understood from the following description by those skilled in the art to which the present disclosure pertains.

According to an embodiment of the present disclosure, provided is an electronic device including: a communication interface; a speaker; a memory storing at least one instruction; and a processor connected to the memory and configured to control the electronic device, wherein the processor is configured to execute the at least one instruction, thereby receiving audio data, data on audio that includes presentation time stamp information when the audio data is required to be output, and time stamp information of an external device from the external device through the communication interface, synchronizing system time of the electronic device with system time of the external device by using the time stamp information of the external device and the time stamp information of the electronic device, storing the audio data in a buffer in the memory based on the synchronized system time and the presentation time stamp information, outputting the audio data stored in the buffer by a first audio clock through the speaker, and changing the first audio clock by comparing the audio data stored in the buffer with a predetermined buffer amount.

The processor may be configured to based on the audio data stored in the buffer being greater than or equal to a first buffer amount, change the first audio clock to a second audio clock higher than the first audio clock, and based on the audio data stored in the buffer being less than a second buffer amount, change the first audio clock to a third audio clock lower than the first audio clock.

The processor may be configured to based on the audio data stored in the buffer being above a reference range of the buffer, change the first audio clock as a second audio clock higher than the first audio clock, and based on the audio data stored in the buffer being below the reference range of the buffer, change the first audio clock as a third audio clock lower than the first audio clock.

The processor may be configured to identify reference time information based on the time stamp information of the external device and the time stamp information of the electronic device, and change the system time of the electronic device to the reference time.

The processor may be configured to receive the data on the audio from the external device through wireless fidelity (WiFi) Direct connection, and receive a control signal for controlling the electronic device from the external device through WiFi connection.

The processor may be configured to transmit information on audio capable of being played by the electronic device to the external device, and receive the audio data capable of being played by the electronic device from the external device.

The processor may be configured to receive, from the external device, the audio data including information on a plurality of channels and information on an audio channel played by the external device, and output the audio data through the speaker by using a channel other than the audio channel.

According to an embodiment of the present disclosure, provided is a control method for an electronic device, the method including: receiving audio data, data on audio that includes presentation time stamp information when the audio data is required to be output, and time stamp information of an external device from the external device; synchronizing system time of the electronic device with system time of the external device by using the time stamp information of the external device and the time stamp information of the electronic device; storing the audio data in a buffer in the memory of the electronic device based on the synchronized system time and the presentation time stamp information; outputting the audio data stored in the buffer by a first audio clock through a speaker of the electronic device; and changing the first audio clock by comparing the audio data stored in the buffer with a predetermined buffer amount.

The changing of the first audio clock comprises, based on the audio data stored in the buffer being greater than or equal to a first buffer amount, changing the first audio clock to a second audio clock higher than the first audio clock, and based on the audio data stored in the buffer being less than a second buffer amount, changing the first audio clock to a third audio clock lower than the first audio clock.

The changing of the first audio clock comprises, based on the audio data stored in the buffer being above a reference range of the buffer, changing the first audio clock to a second audio clock higher than the first audio clock, and based on the audio data stored in the buffer being below the reference range of the buffer, changing the first audio clock to a third audio clock lower than the first audio clock.

The synchronizing of the system time comprises, identifying reference time information based on the time stamp information of the external device and the time stamp information of the electronic device, and changing the system time of the electronic device to the reference time.

The receiving of the data on the audio comprises, receiving the data on the audio may from the external device through wireless fidelity (WiFi) Direct connection, and receiving a control signal for controlling the electronic device from the external device through WiFi connection.

The method may further comprises transmitting information on audio capable of being played by the electronic device to the external device, wherein the receiving of the data on the audio comprises, receiving the audio data capable of being played by the electronic device from the external device.

The method may further comprises: receiving, from the external device, the audio data including information on a plurality of channels and information on an audio channel played by the external device; and outputting the audio data through the speaker by using a channel other than the audio channel.

According to an embodiment of the present disclosure, provided is a non-transitory computer-readable recording medium which includes a program for executing a control method for an electronic device, wherein the method includes receiving audio data, data on audio that includes presentation time stamp information when the audio data is required to be output, and time stamp information of an external device from the external device, synchronizing system time of the electronic device with system time of the external device by using the time stamp information of the external device and the time stamp information of the electronic device, storing the audio data in a buffer in the memory of the electronic device based on the synchronized system time and the presentation time stamp information, outputting the audio data stored in the buffer by a first audio clock through a speaker of the electronic device, and changing the first audio clock by comparing the audio data stored in the buffer with a predetermined buffer amount.

According to the various embodiments of the present disclosure as described above, the electronic device which may output the sound in synchronization with the external device, and the user may thus experience the wider sound stage. It is thus possible to improve the user convenience and satisfaction.

Other effects which may be acquired or predicted by the embodiments of the present disclosure are disclosed directly or implicitly in the detailed description of the embodiments of the present disclosure. That is, various effects predicted based on the embodiments of the present disclosure are disclosed in the detailed description described below.

Hereinafter, the embodiments of the present disclosure are described in detail with reference to the accompanying drawings so that those skilled in the art to which the present disclosure pertains may easily practice the present disclosure.

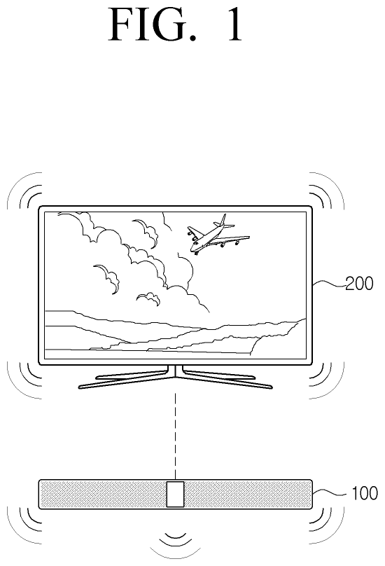

FIG. 1 is a diagram for explaining operations of an electronic device and an external device according to an embodiment of the present disclosure.

An electronic device 100 may output audio data, and an external device 200 may output the audio data and video data. The audio data or the video data, output from the electronic device 100 and the external device 200, may be the audio data and the video data for the same content, and the electronic device 100 and the external device 200 may simultaneously output the audio data or the video data.

Here, the electronic device 100 may output audio in synchronization with audio or video, output from the external device 200.

The electronic device 100 may receive the audio data from the external device 200 to output the audio in synchronization with the external device 200. The electronic device 100 may receive presentation time stamp (PTS) information where the audio data is required to be output from the external device 200 along with time stamp information of the external device 200. In addition, the electronic device 100 may receive data on the audio data from the external device 200 through a wireless fidelity (WiFi) Direct signal, thus minimizing delay time required for transmitting and receiving the data.

In addition, the electronic device 100 may identify reference time information by using the time stamp information of the external device 200 and the time stamp information of the electronic device 100, thereby synchronizing system time of the electronic device 100 with system time of the external device 200, and outputting the audio data based on the reference time information and the PTS information.

That is, the electronic device 100 and the external device 200 may synchronize their system times with each other, and output their audio frames or video frames based on PTS time.

Here, a subtle error may occur in an audio clock of the external device 200 and an audio clock of the electronic device 100 due to various reasons. To correct this error, the electronic device 100 may correct the audio clock of the electronic device 100 based on the audio clock of the external device 200.

Accordingly, the electronic device 100 may output the audio in synchronization with the external device 200.

Here, the electronic device 100 may be a sound bar, is not limited thereto, and may be any of various electronic devices such as a speaker that outputs the audio data. In addition, the external device 200 may be a television (TV), and is not limited thereto. The external device 200 may be any of various electronic devices that output the audio data or the video data, such as a mobile device, or transmit a audio signal to the electronic device 100, such as a set-top box.

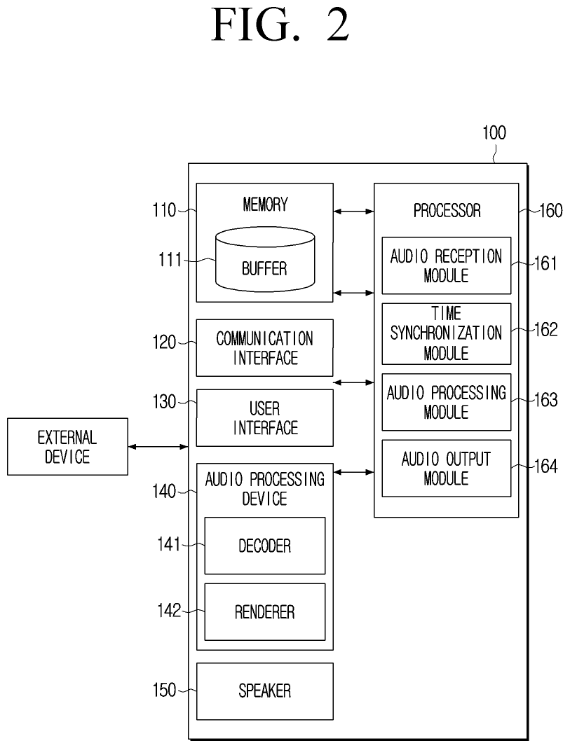

FIG. 2 is a block diagram for explaining a configuration of the electronic device 100 according to an embodiment of the present disclosure.

The electronic device 100 may include a memory 110, a communication interface 120, a user interface 130, an audio processing part 140, a speaker 150, and a processor 160. The electronic device 100 may omit some of the above components, and may further include another component.

The memory 110 may store at least one instruction on the electronic device 100. The memory 110 may store an operating system (O/S) for driving the electronic device 100. In addition, the memory 110 may store various software programs or applications for operating the electronic device 100 according to the various embodiments of the present disclosure. In addition, the memory 110 may include a semiconductor memory such as a flash memory, or a magnetic storing medium such as a hard disk.

In detail, the memory 110 may store various software modules for operating the electronic device 100 according to the various embodiments of the present disclosure, and the processor 160 may allow the various software modules stored in the memory 110 to be executed to control an operation of the electronic device 100. That is, the memory 110 may be accessed by the processor 160, and the processor 160 may perform readout, recording, correction, deletion, update and the like of data therein.

In the present disclosure, the term “memory 110” may include the memory 110, a read only memory (ROM) or a random access memory (RAM) in the processor 160, or a memory card, and for example, a micro secure digital (SD) card or a memory stick) mounted on the electronic device 100.

The communication interface 120 may be a component including circuitry and communicating with the external device and a server. The communication interface 120 may perform the communication with the external device or the server based on a wired or wireless communication method, and can transmit and receive the data. In this case, the communication interface 120 may include a wireless-fidelity (WiFi) module, a WiFi Direct module, a Bluetooth module, an infrared (IR) module, a local area network (LAN) module, an Ethernet module, or the like. Each communication module may be implemented in the form of at least one hardware chip. In addition to the above-described communication methods, a wireless communication module may include at least one communication chip performing the communication based on various wireless communication standards such as zigbee, universal serial bus (USB), mobile industry processor interface camera serial interface (MIPI CSI), third generation (3G), 3rd generation partnership project (3GPP), long term evolution (LTE), LTE advanced (LTE-A), 4th generation (4G), and 5th generation (5G). However, this configuration is only an embodiment, and the communication interface 120 may use at least one communication module among various communication modules.

The electronic device 100 may receive a control command for controlling the electronic device 100 from the external device 200. The command for controlling the electronic device 100 may be a user command input to the external device 200. The electronic device 100 may receive the control command from the external device 200 through the WiFi module.

In addition, the electronic device 100 may receive the audio data, the time stamp information of the external device 200, and the data on the audio that includes the presentation time stamp (PTS) information where the audio data is required to be output through the WiFi Direct module. In this way, the electronic device 100 may receive the audio data by minimizing the delay time required to transmit and receive the audio data, and output the audio data in synchronization with the external device 200.

The user interface 130 may be a component for receiving the user commands to control the electronic device 100. The user interface may be implemented as a device such as a button, a touch pad, a mouse or a keyboard, or may be implemented as a touch screen capable of performing both a display function and a manipulation input function. The button may be any of various types of buttons such as a mechanical button, a touch pad, a wheel or the like, which is disposed in any region, such as the front surface portion, side surface portion, or rear surface portion of a body appearance of the electronic device 100. The electronic device 100 may acquire various user inputs through the user interface 130.

The audio processing part 140 may include a decoder 141 decoding an audio source or the audio data, a renderer 142 generating an output signal based on the audio data decoded by the decoder 141, and an audio encoder generating digital audio data based on the audio data decoded by the decoder 141. An audio output signal generated by the renderer 142 may be transmitted to the speaker 150 and output through the speaker 150.

The speaker 150 may output the audio data. For example, the speaker 150 may output the audio data acquired through the communication interface 120. In addition, the output of the speaker 150 may be controlled by the processor 160. For example, the output clock (or audio clock) or output timing of the speaker 150 may be controlled by the processor 160.

The speaker 150 may include various types of speaker modules. For example, the speaker 150 may include a woofer speaker, a mid-range speaker, or a tweeter.

In addition, the speaker 150 may be disposed in various positions of the electronic device 100. For example, based on the electronic device 100 being the TV, the speaker 150 may be disposed on an upper side of the electronic device 100. However, this position is only an example, and the speaker 150 may be disposed on a lower side of the electronic device 100. In addition, the speaker 150 may output the audio data in various directions. For example, the speaker 150 may output the audio data toward the top of the electronic device 100. However, this configuration is only an example, and the speaker 150 may output the audio data toward the bottom, side, or front of the electronic device 100. In case of receiving multi-channel audio data, the speaker 150 may output the audio based on information on a channel.

The processor 160 may control overall operations and functions of the electronic device 100. In detail, the processor 160 may be connected to the components of the electronic device 100 including the memory 110, and control the overall operations of the electronic device 100 by executing at least one instruction stored in the memory 110 as described above.

The processor 160 may be implemented in various ways. For example, the processor 160 may be implemented as at least one of an application specific integrated circuit (ASIC), an embedded processor, a microprocessor, hardware control logic, a hardware finite state machine (FSM) or a digital signal processor (DSP). In the present disclosure, a term “the processor 160” may be used to include a central processing unit (CPU), a graphic processing unit (GPU), a main processing unit (MPU) or the like.

The processor 160 may include an audio reception module 161, a time synchronization module 162, an audio processing module 163, and an audio output module 164. The plurality of modules according to the present disclosure may be implemented as software modules or hardware modules. Based on the plurality of modules being implemented as the software modules, the processor 160 may access the software modules by loading the software modules stored in the memory 110.

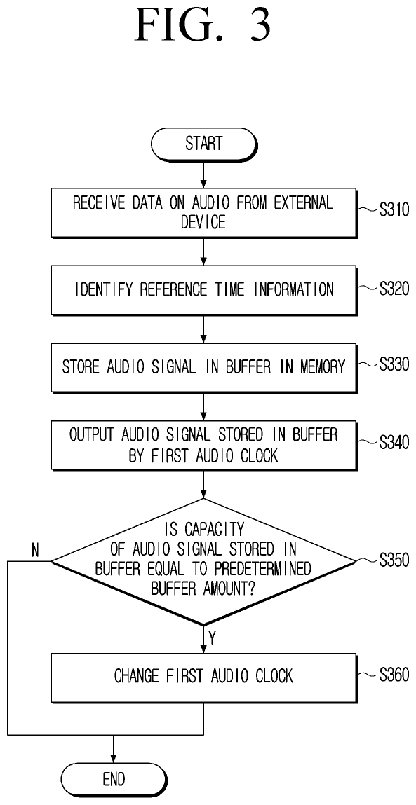

The description describes a method by which the processor controls the operation of the electronic device 100 in detail with reference to FIG. 3.

The audio reception module 161 may receive the audio data, the time stamp information of the external device, and the data on the audio that includes the presentation time stamp (PTS) information where the audio data is required to be output from the external device 200 through the communication interface 120 (S310).

Here, the time stamp information of the external device 200 may be information indicating current time or a current time point based on the external device 200. In addition, the time stamp information of the external device 200 may be information included in a beacon signal for synchronizing the system time of the electronic device 100 with system time of the external device 200. The beacon signal may include the time stamp information of the external device 200 for a beacon frame and beacon interval information indicating a transmission interval.

The time synchronization module 162 may receive the beacon signal including the time stamp information of the external device 200, and identify the reference time information based on the received beacon signal (S320). The reference time information may be the system time of the external device 200 or system time of a WiFi access point (AP), and is not limited thereto.

The time synchronization module 162 may change the system time of the electronic device 100 to the identified reference time information. Accordingly, the system time of the electronic device 100 may be in synchronization with the system time of the external device 200. That is, the time synchronization module 162 may synchronize the system time of the electronic device 100 with system time of the external device 200.

Likewise, the external device 200 may receive a beacon signal including the time stamp information of the electronic device 100, identify the reference time information, and change the system time of the external device 200 to the reference time information.

The presentation time stamp information received by the audio reception module 161 may be information indicating specific time or a specific time point at which the audio data is required to be output.

The audio processing module 163 may store the audio data in a buffer 111 in the memory 110 (or buffer the audio data in the memory 110) based on the synchronized system time (or the reference time information) and the PTS information (S330). The audio processing module 163 may store the PTS information, which is time information where the audio data is required to be output, along with the audio data.

In detail, the audio processing module 163 may store the audio data whose output or play is required to be started within predetermined time from the synchronized system time of the electronic device 100 (or reference time) in the buffer 111 in the memory 110.

For example, based on the reference time (or the system time) being 10:00:00 and the predetermined time is 10 milliseconds (ms), the audio processing module 163 may store the audio data whose output is required to be started at 10:00:00:01.

In some embodiments, the audio processing module 163 may store the audio data in the buffer 111 for a predetermined capacity (e.g., 10 ms). The capacity of the audio data may be a unit of time (e.g., ms) during which the audio data is played.

For example, based on the predetermined capacity being 10 ms, the audio processing module 163 may store the audio data for play time of 10 ms.

In addition, the audio output module 164 may output the audio data stored in the buffer 111 in the memory 110. The audio output module 164 may control the speaker 150 to output the audio data (or each audio frame) stored in the buffer 111 based on the set PTS time. In addition, the audio output module 164 may output the audio data stored in the buffer 111 in the memory 110 in a first-in-first-out manner. The output audio data may be deleted from the buffer 111 in the memory 110. In addition, the audio processing module 163 may store new audio data in the buffer 111 in the memory 110 for a capacity of the audio data deleted from the buffer 111.

In some embodiments, the audio output module 164 may store the audio data in the buffer 111 for a capacity of the audio data received in real time from the external device 200. The external device 200 may transmit the audio data to the electronic device in real time for a capacity of the audio data or a capacity of the video data output by the audio clock of the external device 200.

In addition, the audio output module 164 may output the audio data by a first audio clock (S340). The first audio clock may be a predetermined value or a value received from the external device 200, is not limited thereto, and may be a value set through the user interface 130. In addition, the audio clock may be changed based on a sampling rate of the received audio data.

In addition, the audio clock may indicate an output audio clock frequency (e.g., 48.000 kHz) for outputting the audio through the speaker 150, a sampling clock or the sampling rate for converting the digital audio data to analog audio data.

The audio output module 164 may change the first audio clock by which the audio data is output by comparing the audio data (or the capacity of the audio data) stored in the buffer 111 with a reference buffer amount (e.g., 10 ms). That is, the audio output module 164 may change the audio clock of the electronic device 100 to be in synchronization with the clock of the external device 200. The reference buffer amount may be the predetermined value or a value input through the user interface 130. In some embodiments, the reference buffer amount may be a value that accounts for a predetermined percentage of a capacity of the buffer

In detail, the audio output module 164 may identify whether the capacity of the audio data stored in the buffer 111 is equal to a predetermined buffer amount while the audio is output by the first audio clock (S350).

Based on the capacity of the audio data stored in the buffer 111 is equal to the predetermined buffer amount (S350-N), the audio output module 164 may continuously output the audio by the first audio clock. In detail, the audio output module 164 may output the digital audio data stored in the buffer 111 as an analog audio signal by using a digital to analog converter (DAC) module.

In addition, based on the capacity of the audio data stored in the buffer 111 being more than the predetermined buffer amount or being less than the predetermined buffer amount (S350-Y), the audio output module 164 may change the first audio clock (S360) . That is, the audio output module 164 may output the audio by an audio clock changed from the first audio clock.

Here, based on the capacity of the audio data stored in the buffer 111 being more than the predetermined buffer amount, the audio output module 164 may change the first audio clock to a second audio clock higher than the first audio clock. In addition, based on the capacity of the audio data stored in the buffer 111 is less than the predetermined buffer amount, the audio output module 164 may change the first audio clock to a third audio clock lower than the first audio clock.

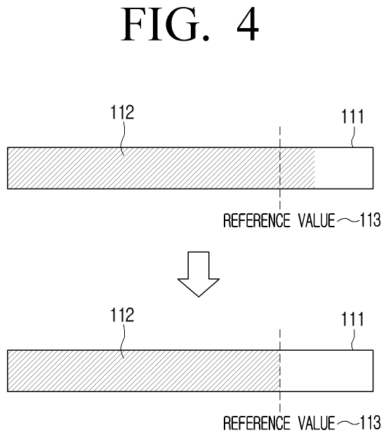

For example, as shown in FIG. 4, a capacity 112 (e.g., 10.1 ms) of the audio data stored in the buffer 111 may be more than a predetermined buffer amount 113 (e.g., 10 ms).

Here, the audio output module 164 may change the output audio clock to the second audio clock (e.g., 48.001 kHz) higher than the first audio clock (e.g., 48.000 kHz).

In other words, the audio data stored in the buffer 111 may be output more quickly as the output audio clock is higher, and the capacity of the audio data stored in the buffer 111 may thus be equal to the predetermined buffer amount.

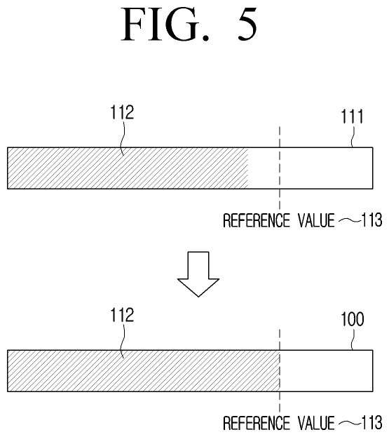

Alternatively, as shown in FIG. 5, the capacity 112 (e.g., 9.9 ms) of the audio data stored in the buffer 111 may be less than the predetermined buffer amount 113 (e.g., 10 ms).

Here, the audio output module 164 may change the output audio clock to the third audio clock (e.g., 47.999 kHz) lower than the first audio clock (e.g., 48.000 kHz).

In other words, the audio data stored in the buffer 111 may be output more slowly as the output audio clock is lower, and the capacity of the audio data stored in the buffer 111 may thus be equal to the predetermined buffer amount.

The description describes that the audio output module 164 changes the first audio clock to the second audio clock based on whether the capacity of the audio data stored in the buffer is equal to the predetermined buffer amount, is not limited to this, and the audio output module 164 may change the first audio clock based on whether the capacity of the audio data stored in the buffer 111 falls within a predetermined range.

In detail, the audio output module 164 may determine whether the capacity of the audio data stored in the buffer 111 falls within the predetermined range of the capacity of the buffer 111.

Based on the capacity of the audio data stored in the buffer 111 being above the predetermined range, the audio output module 164 may change the first audio clock to the second audio clock higher than the first audio clock. In addition, based on the capacity of the audio data stored in the buffer 111 being below the predetermined range, the audio output module 164 may change the first audio clock to the third audio clock lower than the first audio clock.

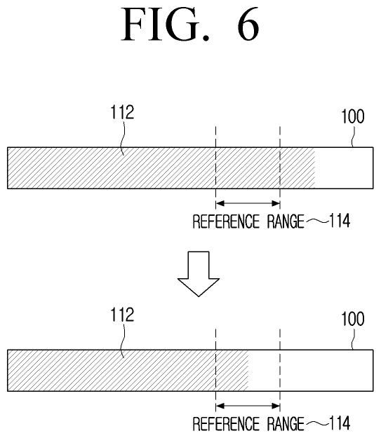

For example, as shown in FIG. 6, the capacity 112 (e.g., 10.1 ms) of the audio data stored in the buffer 111 may be within or above a reference range 114 (e.g., 9.95 ms to 10.05 ms) of the predetermined buffer amount. The audio output module 164 may change the output audio clock to the second audio clock (e.g., 48.001 kHz) higher than the first audio clock (e.g., 48.000 kHz).

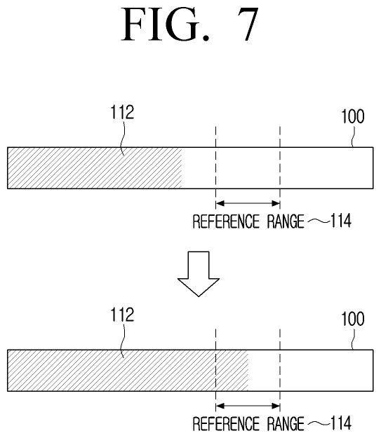

Alternatively, as shown in FIG. 7, the capacity 112 (e.g., 9.9 ms) of the audio data stored in the buffer 111 may be within or below the reference range 114 (e.g., 9.95 ms to 10.05 ms) of the predetermined buffer amount. The audio output module 164 may change the output audio clock to the third audio clock (e.g., 47.999 kHz) lower than the first audio clock (e.g., 48.000 kHz).

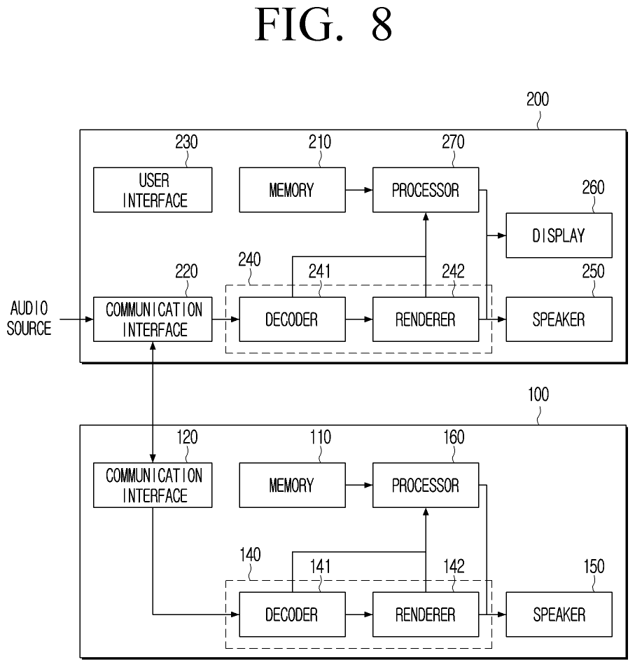

FIG. 8 is a diagram for explaining a system including the electronic device 100 and the external device 200 according to an embodiment of the present disclosure.

Here, the external device 200 may include a memory 210, a communication interface 220, a user interface 230, an audio processing device 240, a speaker 250, a display 260, and a processor 270. Each component of the external device 200 may be operated in the same manner as each component of the electronic device 100 described with reference to FIG. 2, and its redundant description is thus omitted.

The external device 200 may acquire the audio source through the communication interface 220. The audio source may indicate encoded digital audio data. The external device 200 may decode the audio source through a decoder 241. In addition, the external device 200 may generate the audio output signal through a renderer 242. In addition, the external device 200 may output the audio output signal through the speaker 250.

Here, the processor 270 of the external device 200 may transmit the audio source (or the audio data) to the electronic device 100 through the communication interface 220. The electronic device 100 may receive the audio source through the communication interface 120. In addition, the electronic device 100 may output the audio output signal generated through the audio processing part 140 to the speaker 150.

Here, the external device 200 may transmit the audio source through WiFi connection or WiFi Direct connection, and may transmit the audio source based on the time information where the audio source is required to be output.

In addition, the external device 200 may stop transmitting data that failed to be transmitted and transmit subsequent data at normal time in case of continuously failing to transmit for a certain time period or more to a deteriorated wireless environment.

In addition, the external device 200 may not necessarily have to transmit the acquired audio source to the electronic device 100 as it is. That is, the external device 200 may transmit the audio data decoded through the decoder 241 to the electronic device 100. The electronic device 100 may generate an output audio signal based on the decoded audio data through the renderer 142. The decoded audio data may be delivered to the renderer 142 by bypassing the decoder 141.

The processor 270 of the external device 200 and the processor 160 of the electronic device 100 may respectively control the outputs of the speaker 250 of the external device 200 and the speaker 150 of the electronic device 100. In detail, the processor 270 of the external device 200 and the processor 160 of the electronic device 100 may respectively control the output timings, output levels, or output audio clocks of the speaker 250 of the external device 200 and the speaker 150 of the electronic device 100.

FIG. 8 shows that the external device 200 acquires the audio source and transmits the same to the electronic device 100, which is only an example, and the electronic device may acquire the audio source from a separate external device (e.g., set-top box). In addition, the electronic device 100 may acquire the audio source and transmit the same to the external device 200.

In addition, the external device 200 and the electronic device 100 may have a master-slave relationship. A master device may indicate a device generating a final output audio signal of each device from the audio source. In addition, a slave device may indicate the device receiving and outputting the output audio signal generated by the master device.

For example, the external device 200 may be operated as the master device, and the electronic device 100 may be operated as the slave device. The external device 200 may generate a first output audio signal output through the speaker 250 and a second output audio signal output through the speaker 150. In addition, the external device 200 may transmit the generated second output audio signal to the electronic device 100. The second output audio signal transmitted to the electronic device 100 may be output through the speaker 150 by bypassing the audio processing part 140. It is thus possible to reduce signal processing time occurring in an audio signal processing device 221 of the electronic device 100. In particular, signal processing performance of the external device 200 may be higher than signal processing performance of the electronic device 100. In this case, the signal processing time occurring in the electronic device 100 may be reduced, thereby reducing the signal processing time of the entire audio system.

In addition, the external device 200 may be operated as the slave device, and the electronic device 100 may be operated as the master device. For example, the electronic device 100 may be directly connected to the external source device (e.g., set-top box) providing the audio source. In this case, the electronic device 100 may generate the first output audio signal output through the speaker 250 of the external device 200 and the second output audio signal output through the speaker 150 of the electronic device 100. In addition, the electronic device 100 may transmit the generated first output audio signal to the external device 200. The first output audio signal transmitted to the external device 200 may be output through the speaker 250 by bypassing the audio processing device 240 of the external device 200.

The master device may be a device directly acquiring the audio source, which is only an example, and the master device may receive the audio source acquired by the slave device. The master device may generate the output audio signal based on the acquired audio source and transmit the same to the slave device. For example, the external device 200 may be operated as the slave device. In this case, the external device 200 may acquire the audio source and transmit the same to the electronic device 100 which is the master device. The electronic device 100 may generate a first output signal based on the received audio source and transmit the same to the external device 200. The external device 200 may output the first output signal through the speaker 250. In particular, the decoder 141 of the electronic device 100 which is the master device may process more various formats than the decoder 241 of the external device 200 or have superior computing power. In this case, the external device 200 may receive the first output signal generated by the electronic device 100 and output the same, thereby reducing the signal processing time.

In addition, to output the audio data while being in synchronization with each other, the external device 200 and the electronic device 100 may exchange information on the audio or device. The information on the audio or device may include a model name of the electronic device 100 or that of the external device 200, a configuration of the speaker, output of the speaker, the number of channels of the speaker, a location of the speaker, an audio processing method, audio data processing time, an audio format that may be processed, decoding time, rendering time, and time required to transmit and receive the data based on a type of the communication interface, the audio clock information, information on a sound field, or the like of the electronic device 100 or that of the external device 200.

The electronic device 100 may output the audio based on the information on the audio or device that is received from the external device 200.

In detail, the external device 200 and the electronic device 100 may output audio signals for the same content, and output audio signals with different components of the audio data.

The electronic device 100 may receive, from the external device 200, the information on the channel which may be output by the external device 200, and the processor 160 of the electronic device 100 may output the audio data through a channel other than a channel which may be played by the external device 200 based on the audio data received from the external device 200 being the multi-channel audio data.

For example, the external device 200 may output a top signal by using the above-described method, and the electronic device 100 may output a front signal or a bottom signal.

In addition, the electronic device 100 may transmit information on the audio format that may be processed by the electronic device 100 to the external device 200. Accordingly, the electronic device 100 may receive the audio data from the external device 200 in the audio format that may be processed by the electronic device 100.

In addition, the electronic device 100 may receive, from the external device 200, the information on the sound field for the electronic device 100 to output the audio data. The processor 160 of the electronic device 100 may control the speaker 150 based on the received information on the sound field and output the audio data.

The electronic device 100 and the external device 200 may be connected to each other by a near field communication method. First, the external device 200 may scan a peripheral device through the communication interface 220 to search for a device which may output the audio in synchronization with the external device 200, and communicate with the electronic device 100 by a Bluetooth method. In addition, the external device 200 may transmit information its connection to the WiFi AP to the electronic device 100 through Bluetooth connection. The external device 200 may perform the communication by various methods such as high-definition multimedia interface (HDMI) connection and optical cable connection, in addition to the Bluetooth connection.

As the electronic device 100 receives the information its connection to the WiFi AP, the electronic device 100 may communicate with the external device 200 through the WiFi AP. Accordingly, the electronic device 100 may receive the data on the audio by the WiFi Direct method and output the audio data in synchronization with the external device 200.

A method by which the electronic device 100 and the external device 200 are connected to each other is not limited to the method described above, and the communication between the electronic device 100 and the external device 200 may be connected through a user terminal device connected to the electronic device 100.

The description describes above that the electronic device 100 plays the audio data in synchronization with the external device 200, which is only an embodiment, and the electronic device 100 may also play the audio data in synchronization with a plurality of devices.

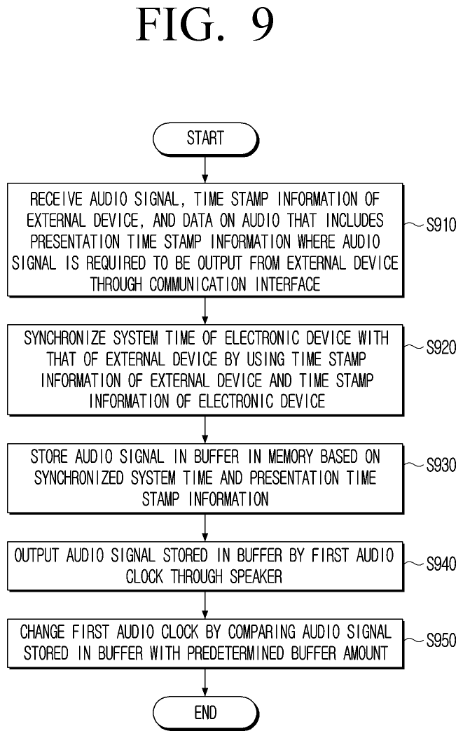

FIG. 9 is a diagram for explaining a control method of an electronic device 100 according to an embodiment of the present disclosure.

The electronic device 100 may receive the audio data, the time stamp information of the external device, and the data on the audio that includes the presentation time stamp information where the audio data is required to be output from the external device through the communication interface 120 (S910).

The electronic device may synchronize the system time of the electronic device 100 with system time of the external device 200 by using the time stamp information of the external device and the time stamp information of the electronic device (S920). In detail, the electronic device 100 may identify the reference time information and change the system time of the electronic device to the reference time based on the time stamp information of the external device and the time stamp information of the electronic device.

The electronic device 100 may store the audio data in the buffer 111 in the memory based on the synchronized system time and the presentation time stamp information (S930).

The electronic device 100 may output the audio data stored in the buffer 111 by the first audio clock through the speaker (S940).

The electronic device 100 may change the first audio clock by comparing the audio data stored in the buffer 111 with the predetermined buffer amount (S950). In detail, the electronic device 100 may output the audio data by the second audio clock higher than the first audio clock through the speaker based on the audio data stored in the buffer being more than a first buffer amount, and output the audio data by the third audio clock lower than the first audio clock through the speaker based on the audio data stored in the buffer being less than a second buffer amount.

Meanwhile, the term “˜er/˜or” or “module” used in the present disclosure may include a unit including hardware, software or firmware, and may be used interchangeably with the term, for example, logic, a logic block, a component or a circuit. The “˜er/˜or” or “module” may be an integrally formed component, or a minimum unit or part performing one or more functions. For example, the module may include the application-specific integrated circuit (ASIC).

The various embodiments of the present disclosure may be implemented by software including an instruction stored in a machine-readable storage medium (for example, a computer-readable storage medium). A machine may be a device that invokes the stored instruction from the storage medium and may be operated based on the invoked instruction, and may include the electronic device 100 according to the disclosed embodiments. In case that the instruction is executed by the processor, the processor may directly perform a function corresponding to the instruction or other components may perform the function corresponding to the instruction under the control of the processor. The instruction may include a code provided or executed by a compiler or an interpreter. The machine-readable storage medium may be provided in the form of a non-transitory storage medium. A term “non-transitory” may indicate that the storage medium is tangible without including a signal, and does not distinguish whether data are semi-permanently or temporarily stored in the storage medium.

According to an embodiment, the method according to the various embodiments disclosed in the present disclosure may be provided by being included in a computer program product. The computer program product may be traded as a product between a seller and a purchaser. The computer program product may be distributed in a form of the machine-readable storage medium (for example, a compact disc read only memory (CD-ROM)), or may be distributed online through an application store (for example, PlayStore™). The computer program product may be distributed in a form of the machine-readable storage medium (for example, a compact disc read only memory (CD-ROM)), or may be distributed online through an application store (for example, PlayStore™). In case of the online distribution, at least some of the computer program products may be at least temporarily stored in the storage medium such as a memory of a server of a manufacturer, a server of an application store, or a relay server, or be temporarily generated.

Each component (e.g., module or program) in the various embodiments may include a single entity or a plurality of entities, and some of the corresponding sub-components described above may be omitted or other sub-components may be further included in the various embodiments. Alternatively or additionally, some of the components (e.g., modules or programs) may be integrated into one entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

What is claimed is:

1. An electronic device comprising:
a communication interface;
a speaker;
memory storing at least one instruction; and
at least one processor connected to the memory and configured to control the electronic device,
wherein the at least one processor is configured to execute the at least one instruction, and the at least one instruction causes the at least one processor to:
receive audio data and data on the audio data, wherein data on the audio data comprises a presentation time stamp information indicating when the audio data is required to be output, and a time stamp information of an external device,
synchronize a system time of the electronic device with a system time of the external device by using a time stamp information of the electronic device and the time stamp information of the external device,
store the audio data in a buffer in the memory based on the system time of the electronic device and the presentation time stamp information,
output the audio data stored in the buffer by a first audio clock through the speaker, and
change the first audio clock by comparing the audio data stored in the buffer with a predetermined buffer amount.

2. The electronic device as claimed in claim 1, wherein the at least one instruction further causes the at least one processor to:
based on the audio data stored in the buffer being greater than or equal to a first buffer amount, change the first audio clock to a second audio clock higher than the first audio clock, or
based on the audio data stored in the buffer being less than a second buffer amount, change the first audio clock to a third audio clock lower than the first audio clock.

3. The electronic device as claimed in claim 1, wherein the at least one instruction further causes the at least one processor to:
based on the audio data stored in the buffer being within or higher than a reference range of the buffer, change the first audio clock as a second audio clock higher than the first audio clock, and
based on the audio data stored in the buffer being lower than the reference range of the buffer, change the first audio clock as a third audio clock lower than the first audio clock.

4. The electronic device as claimed in claim 1, wherein the at least one instruction further causes the at least one processor to:
identify reference time information based on the time stamp information of the external device and the time stamp information of the electronic device, and
change the system time of the electronic device to the reference time.

5. The electronic device as claimed in claim 1, wherein the data on the audio data from the external device is received through wireless fidelity (WiFi) Direct connection, and wherein the at least one instruction further causes the at least one processor to receive a control signal for controlling the electronic device from the external device through WiFi connection.

6. The electronic device as claimed in claim 1, wherein the at least one instruction further causes the at least one processor to:
transmit information on audio capable of being played by the electronic device to the external device, and
receive the audio data capable of being played by the electronic device from the external device.

7. The electronic device as claimed in claim 1, wherein the at least one processor is configured to:
receive, from the external device, the audio data including information on a plurality of channels and information on an audio channel played by the external device, and
output the audio data through the speaker by using a channel other than the audio channel.

8. A method for controlling an electronic device, the method comprising:
receiving audio data and data on the audio data, wherein data on the audio data comprises a presentation time stamp information indicating when the audio data is required to be output, and a time stamp information of an external device;
synchronizing a system time of the electronic device with a system time of the external device by using a time stamp information of the electronic device and the time stamp information of the external device;
storing the audio data in a buffer in the memory of the electronic device based on the system time of the electronic device and the presentation time stamp information;
outputting the audio data stored in the buffer by a first audio clock through a speaker of the electronic device; and
changing the first audio clock by comparing the audio data stored in the buffer with a predetermined buffer amount.

9. The method as claimed in claim 8, wherein in the changing of the first audio clock comprises:
based on the audio data stored in the buffer being greater than or equal to a first buffer amount, changing the first audio clock to a second audio clock higher than the first audio clock, and
based on the audio data stored in the buffer being less than a second buffer amount, changing the first audio clock to a third audio clock lower than the first audio clock.

10. The method as claimed in claim 8, wherein in the changing of the first audio clock comprises,
based on the audio data stored in the buffer being higher than a reference range of the buffer, changing the first audio clock to a second audio clock higher than the first audio clock, and
based on the audio data stored in the buffer being lower than the reference range of the buffer, changing the first audio clock to a third audio clock lower than the first audio clock.

11. The method as claimed in claim 8, wherein in the synchronizing of the system time comprises,
identify reference time information based on the time stamp information of the external device and the time stamp information of the electronic device, and
change the system time of the electronic device to the reference time.

12. The method as claimed in claim 8, wherein in the receiving the data on the audio data comprises: receiving the data on the audio data from the external device through wireless fidelity (WiFi) Direct connection, and
wherein the method further comprises receiving a control signal for controlling the electronic device from the external device through WiFi connection.

13. The method as claimed in claim 8, further comprising:
transmitting information on audio capable of being played by the electronic device to the external device,
wherein the receiving the audio data comprises,
receiving the audio data capable of being played by the electronic device from the external device.

14. The method as claimed in claim 8, further comprising:
receiving, from the external device, the audio data including information on a plurality of channels and information on an audio channel played by the external device; and
outputting the audio data through the speaker by using a channel other than the audio channel.

15. A non-transitory computer-readable medium, comprising a program stored therein, the program being executable by at least one processor to:
receive audio data, wherein data on the audio data comprises a presentation time stamp information indicating when the audio data is required to be output, and a time stamp information of an external device,
synchronize a system time of the electronic device with a system time of the external device by using a time stamp information of the electronic device and the time stamp information of the external device,
store the audio data in a buffer in the memory of the electronic device based on the system time of the electronic device and the presentation time stamp information,
output the audio data stored in the buffer by a first audio clock through a speaker of the electronic device, and
change the first audio clock by comparing the audio data stored in the buffer with a predetermined buffer amount.

16. The non-transitory computer-readable medium as claimed in claim 15, wherein the program is further executable by the at least one processor to:
based on the audio data stored in the buffer being greater than or equal to a first buffer amount, change the first audio clock to a second audio clock higher than the first audio clock, or
based on the audio data stored in the buffer being less than a second buffer amount, change the first audio clock to a third audio clock lower than the first audio clock.

17. The non-transitory computer-readable medium as claimed in claim 15, wherein the program is further executable by the at least one processor to:
based on the audio data stored in the buffer being within or higher than a reference range of the buffer, change the first audio clock as a second audio clock higher than the first audio clock, and
based on the audio data stored in the buffer being lower than the reference range of the buffer, change the first audio clock as a third audio clock lower than the first audio clock.

18. The non-transitory computer-readable medium as claimed in claim 15, wherein the program is further executable by the at least one processor to:
identify reference time information based on the time stamp information of the external device and the time stamp information of the electronic device, and
change the system time of the electronic device to the reference time.

19. The non-transitory computer-readable medium as claimed in claim 15, wherein the data on the audio data from the external device is received through wireless fidelity (WiFi) Direct connection, and
wherein the program is further executable by the at least one processor to receive a control signal for controlling the electronic device from the external device through WiFi connection.

20. The non-transitory computer-readable medium as claimed in claim 15, wherein the program is further executable by the at least one processor to:
transmit information on audio capable of being played by the electronic device to the external device, and
receive the audio data capable of being played by the electronic device from the external device.
